(19) United States
(12) Patent Application Publication
(10) Pub. No.: US 2020/0278423 A1
(43) Pub. Date: Sep. 3, 2020

(54) REMOVING FALSE ALARMS AT THE BEAMFORMING STAGE FOR SENSING RADARS USING A DEEP NEURAL NETWORK

(71) Applicant: GM GLOBAL TECHNOLOGY OPERATIONS LLC, Detroit, MI (US)

(72) Inventors: Eyal Rittberg, Petach Tikva (IL); Omri Rozenzaft, Herzliya (IL)

(73) Assignee: GM GLOBAL TECHNOLOGY OPERATIONS LLC, Detroit, MI (US)

(21) Appl. No.: 16/290,159

(22) Filed: Mar. 1, 2019

(51) Int. Cl. G01S 7/41; G01S 13/04

(52) U.S. Cl. CPC G01S 7/417; G01S 13/04

(57) ABSTRACT

Processor-implemented methods and systems that perform target verification on a spectral response map to remove false alarm detections at the beamforming stage for sensing radars (i.e., prior to performing peak response identification) using a convolutional neural network (CNN) are provided. The processor-implemented methods include: generating a spectral response map from the radar data; and, executing the CNN to determine whether the response map represents a valid target detection and to classify the response map as a false alarm when the response map does not represent a valid target detection. Subsequent to the execution of the CNN, only response maps with valid targets are processed to generated therefrom a direction of arrival (DOA) command.

### TECHNICAL FIELD

The present disclosure relates generally to object perception systems that process sensed radar data, and more particularly to removing false alarms at the beamforming stage for sensing radars using a deep neural network.

The trend toward vehicle automation includes therewith a demand for enhanced vehicle perception systems. Radar data, from radar transceivers, can provide one opportunity for a driving system to “perceive” the environment external to the vehicle. Specifically, radar data can be used to identify and generate a “direction of arrival” (DOA) command with respect to a target object, which is basically information that, at a certain location, there is a target object. The location may further be with respect to frame of reference of a user or a mobile platform.

In many conventional direction of arrival (DOA) systems, the radar data is converted with a beamforming algorithm into a spectral image called a response map. The response map is is a function of two variables (or dimensions), such as an azimuth (x-axis) and an elevation (y-axis) tuple, and each (x,y) tuple in the response map has an associated energy related to it. The response map is an image, or snapshot, representing the external environment of the vehicle. The spectral map is then processed by a peak response algorithm to identify a peak, or most intense, response. The peak response is used to indicate a direction of arrival of the target object. In various embodiments, “the beamforming stage” includes the execution of the beamforming algorithm plus the execution of the peak response identification.

However, in sensitive radar systems, the spectral images sometimes have false alarms, which can be caused by a variety of things, such as environmental noise. Many conventional systems for determining a DOA with radar data can be tricked by the false alarms. When a false alarm is misinterpreted to indicate a valid target, a DOA is generated indicating the presence of an object where there is none. In a driving system that relies on the DOA to make decisions about continuing along a current travel path, the false alarm DOAs can lead to undesirable results, events such as stopping the vehicle, perhaps indefinitely, unnecessary braking, jittery driving, and navigating the vehicle around false alarms (i.e., imaginary object). Further, mobile platforms that utilize the conventional DOA systems waste time correcting after each of these events.

Accordingly, a technologically improved direction of arrival (DOA) system that receives and operates on radar data is desirable. The desired DOA system is adapted to make fast determinations about false alarms to eliminate them quickly before other systems rely on them. The desired DOA system employs a convolution neural net (CNN) in the performance of target verification and false alarm (FA) elimination at the beamforming stage for sensing radars. The following disclosure provides these technological enhancements, in addition to addressing related issues.

### SUMMARY

A processor-implemented method for using radar data to generate a direction of arrival (DOA) command using a convolutional neural network (CNN) is provided. The method includes: generating a response map from the radar data; processing, in the CNN, the response map to determine whether the response map represents a valid target detection; classifying, by the CNN, the response map as a false alarm when the response map does not represent a valid target detection; and identifying a maximum value in the response map when the response map does represent a valid target detection.

In an embodiment, the response map is a Bartlett beamformer spectral response map.

In an embodiment, the CNN has been trained using training data generated in an anechoic chamber.

In an embodiment, the response map is a three-dimensional tensor of dimensions 15×20×3.

In an embodiment, the CNN is trained using back propagation.

In an embodiment, the CNN comprises a plurality of hidden layers.

In an embodiment, each of the hidden layers comprise a convergent layer with a rectified linear unit (ReLU) activation function.

In an embodiment, each of the hidden layers further comprise Batch Normalization layers, MaxPooling layers, and Dropout layers.

In an embodiment, the CNN comprises at least one fully connected layer (FC) with a sigmoid activation function.

In another embodiment, a processor-implemented method for removing false alarms at the beamforming stage for sensing radars using a convolutional neural network (CNN) is provided. The method includes: receiving a response map generated from radar data; processing, in the CNN, the response map to determine whether the response map represents a valid target detection; classifying, by the CNN, the response map as a false alarm when the response map does not represent a valid target detection; and classifying, by the CNN, the response map as a valid response map when the response map does represent a valid target detection.

In an embodiment, the response map is a Bartlett beamformer spectral response map.

In an embodiment, the CNN has been trained using training data generated in an anechoic chamber and validation data generated in the anechoic chamber.

In an embodiment, the CNN is trained using back propagation.

In an embodiment, the response map is a three-dimensional tensor of dimensions 15×20×3, and the CNN comprises a number, N, of hidden layers, wherein N is a function of at least the dimensions of the response map.

In an embodiment, each of the N hidden layers comprise a convergent layer with a rectified linear unit (ReLU) activation function.

In an embodiment, the N hidden layers are interspersed with Batch Normalization layers, MaxPooling layers, and Dropout layers.

In an embodiment, the CNN comprises at least one fully connected layer (FC) with a sigmoid activation function.

In another embodiment, a system for generating a direction of arrival (DOA) command for a vehicle having one or more processors programmed to implement a convolutional neural network (CNN) is provided. The system includes: a radar transceiver providing radar data; a processor programmed to receive the radar data and generate therefrom a Bartlett beamformer response map; and wherein the CNN is trained to process the response map to determine whether the response map represents a valid target detection, and classify the response map as a false alarm when the response map does not represent a valid target detection; and wherein the processor is further programmed to generate the DOA command when the response map does represent a valid target detection.

In an embodiment, the processor is further programmed to identify a peak response in the response map when the response map does represent a valid target detection.

In an embodiment, the processor is further programmed to train the CNN using back propagation and using a training data set and a validation data set that are each generated in an anechoic chamber.

### BRIEF DESCRIPTION OF THE DRAWINGS

Aspects of the present disclosure are best understood from the following detailed description when read with the accompanying figures, wherein like numerals denote like elements, and:

FIG. 1 is a block diagram depicting an example vehicle, in accordance with some embodiments;

FIG. 2 is a block diagram depicting an example driving system in an example vehicle, in accordance with some embodiments;

FIG. 3 is a block diagram depicting an example direction of arrival system for a vehicle, in accordance with some embodiments;

FIG. 4 is a diagram indicating the arrangement of the layers of a CNN, in accordance with some embodiments;

FIG. 5 is a process flow chart depicting an example process for training the CNN, in accordance with some embodiments;

FIG. 6 is a process flow chart depicting an example process for operation of a DOA system that uses a trained CNN, in accordance with some embodiments; and

FIGS. 7 and 8 are exemplary embodiments of false alarm elimination logic, in accordance with some embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description.

Embodiments of the present disclosure may be described herein in terms of functional and/or logical block components and various processing steps. Accordingly, it should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices.

For the purpose of the description, various functional blocks and their associated processing steps may be referred to as a module. As used herein, each “module” may be implemented in any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

In a sensitive radar perception system, “noise” in the radar data can potentially cause a false alarm. Some non-limiting examples of things collectively called “noise” include the exhaust of a smokestack, insects, a piece of trash floating through the air, weather, and the like. As mentioned, the effects of making a DOA determination that indicates a direction to a valid target when the target is, in fact, invalid, can be undesirable. In various embodiments, the DOA is used to cause a vehicle to turn and/or to brake. In an example, a mobile platform that makes steering decisions upon receipt of the DOA, the mobile platform makes a high level of turns, including many that are unnecessary, per distance traveled; a passenger would experience the mobile platform as providing a jittery ride. In another example, a mobile platform that makes braking decisions upon receipt of the DOA, the mobile platform brakes frequently, including for many unnecessary reasons, per distance traveled; a passenger would also experience the mobile platform as providing a jittery ride. As mentioned, this is a technological problem that some conventional direction of arrival (DOA) systems cannot resolve.

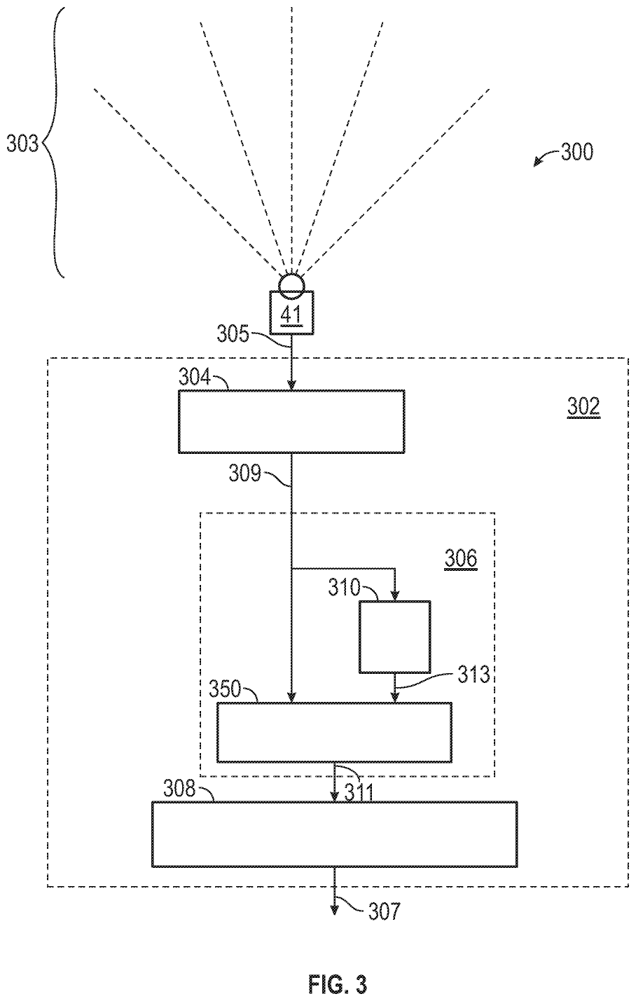

Provided herein is a technologically improved direction of arrival (DOA) system (FIG. 3, 302) that receives and operates on radar data. The DOA system introduces a novel target validation module (FIG. 3, 306) that employs a convolution neural net (CNN) (FIG. 3, 310) with false alarm elimination logic (FIG. 3, 350). The CNN 310 performs target verification on the beamformed response map, and the false alarm elimination logic 350 removes false alarm detections in the beamforming stage for sensing radars based on the output of the CNN 310. This technological enhancement provides a functional improvement of assuring that only valid response maps are processed to generate a DOA command. The practical effect of this improvement can be seen and experienced in systems that use the DOA to make decisions; for example, in a mobile platform that uses the DOA in steering and braking operations, turning and braking will only be done in response to valid objects, which translates into a smoother drive and more comfortable ride for a passenger.

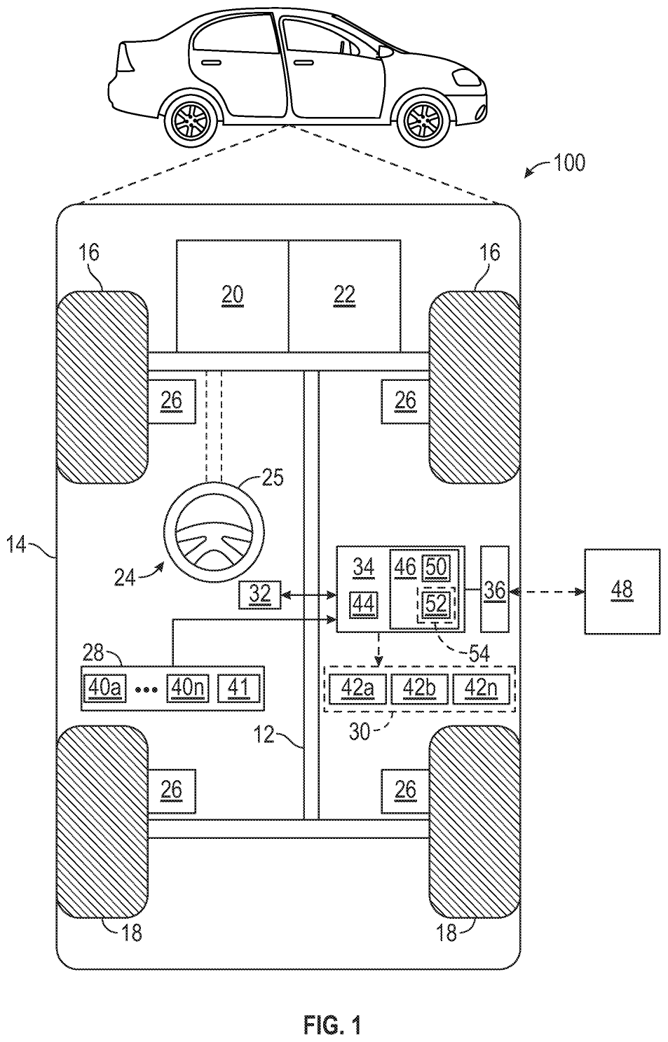

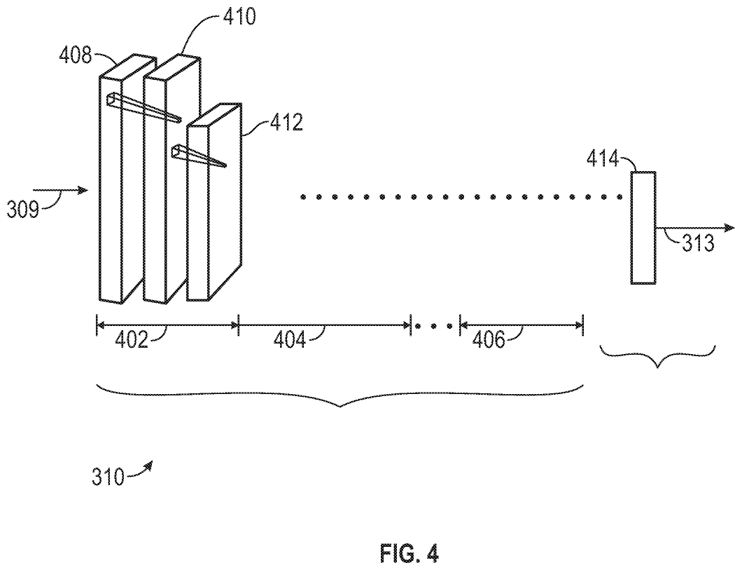

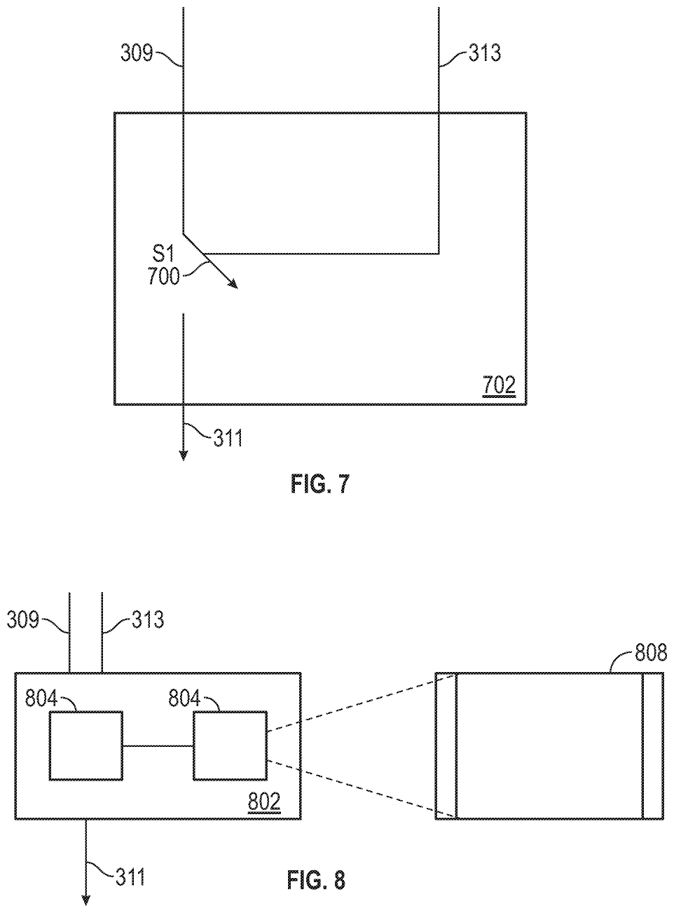

The description below follows this general order: A vehicle and the general context for a DOA system are provided with FIGS. 1-3; FIGS. 4-6 introduce features of the novel DOA system and the implementation of the CNN 310; and FIGS. 7-8 depict some example embodiments of the false alarm detection logic (FIG. 3, 350).

FIG. 1 depicts an example vehicle 100. While the DOA system 302 is described in the context of a mobile platform that is a vehicle, it is understood that embodiments of the novel DOA system 302 and/or the target validation module 306 that employs a convolution neural net (CNN) may be practiced in conjunction with any number of mobile and immobile platforms, and that the systems described herein are merely exemplary embodiments of the present disclosure. In various embodiments, the vehicle 100 may be capable of being driven autonomously or semi-autonomously. The vehicle 100 is depicted in the illustrated embodiment as a passenger car, but other vehicle types, including motorcycles, trucks, sport utility vehicles (SUVs), recreational vehicles (RVs), marine vessels, aircraft, etc., may also be used.

The vehicle 100 generally includes a chassis 12, a body 14, front wheels 16, and rear wheels 18. The body 14 is arranged on the chassis 12 and substantially encloses components of the vehicle 100. The body 14 and the chassis 12 may jointly form a frame. The wheels 16-18 are each rotationally coupled to the chassis 12 near a respective corner of the body 14.

As shown, the vehicle 100 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel. The steering system 24 is configured to receive control commands from the controller 34 such as steering angle or torque commands to cause the vehicle 100 to reach desired trajectory waypoints. The steering system 24 can, for example, be an electric power steering (EPS) system, or active front steering (AFS) system.

The sensor system 28 includes one or more sensing devices 40a-40n that sense observable conditions of the exterior environment and/or the interior environment of the vehicle 100 (such as the state of one or more occupants) and generate sensor data relating thereto. Sensing devices 40a-40n might include, but are not limited to: global positioning systems (GPS), optical cameras (e.g., forward facing, 360-degree, rear-facing, side-facing, stereo, etc.), thermal (e.g., infrared) cameras, ultrasonic sensors, lidars, odometry sensors (e.g., encoders) and/or other sensors that might be utilized in connection with systems and methods in accordance with the present subject matter.

The above referenced radar data is provided by a sensing radar, radar transceiver 41, which is shown as being a component of the sensor system 28. The radar transceiver 41 may be one or more commercially available radars (e.g., long-range, medium-range, and short range). As is described in more detail in connection with FIG. 3, radar data from the radar transceiver 41 is used the determination of the direction of arrival (DOA). In various embodiments, the vehicle position data from the GPS sensors is also used by the controller 34 in the calculation of the DOA.

The actuator system 30 includes one or more actuator devices 42a-42n that control one or more vehicle features such as, but not limited to, the propulsion system 20, the transmission system 22, the steering system 24, and the brake system 26.

The data storage device 32 may store data for use in controlling the vehicle 100. In various embodiments, the data storage device 32 stores defined maps of the navigable environment. In various embodiments, the defined maps may be predefined by and obtained from a remote system. For example, the defined maps may be assembled by the remote system and communicated to the vehicle 100 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be integrated with the controller 34 or may be separate from the controller 34.

In various embodiments, the controller 34 includes at least one processor 44 and a computer-readable storage device or media 46. The processor 44 may be one or more of: a custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions.

The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions 50, used by the controller 34 in controlling the vehicle 100. Instructions 50 also include commercially available programs and algorithms employed in the operation of a DOA system (FIG. 3, 302), and in particular, an algorithm that employs spectral methods (such as a Bartlett beamforming algorithm and a peak response identifier algorithm) for estimating a DOA as a function of a spectral image, which are described in more detail in connection with FIGS. 3-6.

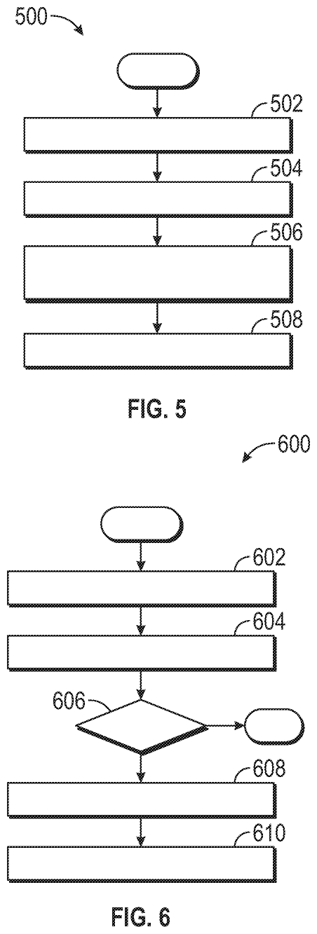

One or more separate novel programs, and specifically, a false alarm (FA) detection program 52, may also be stored in the computer-readable storage device or media 46. The false alarm (FA) detection program 52 includes an ordered listing of executable instructions and associated preprogrammed variables for implementing the logical functions, operations, and tasks of the disclosed DOA system 302 that employs a convolutional neural network (CNN 310, FIG. 3) to classify a spectral response map as a false alarm when it does not represent a valid target detection. The FA detection program 52 is described in in connection with FIGS. 5-8.

Those skilled in the art will recognize that the algorithms and instructions of the present disclosure are capable of being distributed as a program product 54. As a program product 54, one or more types of non-transitory computer-readable signal bearing media may be used to store and distribute the program 52, such as a non-transitory computer readable medium bearing the program 52 and containing therein additional computer instructions for causing a computer processor (such as the processor 44) to load and execute the program 52. Such a program product 54 may take a variety of forms, and the present disclosure applies equally regardless of the type of computer-readable signal bearing media used to carry out the distribution. Examples of signal bearing media include: recordable media such as floppy disks, hard drives, memory cards and optical disks, and transmission media such as digital and analog communication links. It will be appreciated that, in various embodiments, cloud-based storage and/or other techniques may also be utilized as media 46 and provide time-based performance of program 52.

In various embodiments, the communication system 36 is configured to incorporate an input/output device, and to support instantaneous (i.e., real time or current) communications between on-vehicle systems, the processor 44, and one or more external data source(s) 48. The communications system 36 may incorporate one or more transmitters, receivers, and the supporting communications hardware and software required for components of the controller 34 to communicate as described herein. Also, in various embodiments, the communications system 36 may support communication with technicians, and/or one or more storage interfaces for direct connection to storage apparatuses, such as the data storage device 32.

Although only one controller 34 is shown in FIG. 1, in various embodiments of the vehicle 100, the controller 34 functionality may be distributed among any number of controllers 34, each communicating over communication system 36, or other suitable communication medium or combination of communication mediums. In these embodiments the one or more distributed controllers 34 cooperate in the processing of the sensor signals, the performance of the logic, calculations, methods and/or algorithms for controlling the components of the vehicle 100 operation as described herein.

Thus, a general context for the DOA system 302 is provided. Next, the controller functionality is described. The software and/or hardware components of controller 34 (e.g., processor 44 and computer-readable storage media 46, having stored therein instructions) cooperate to provide the herein described controller 34 and DOA system 302 functionality. Specifically, the instructions 50 and program 52, when executed by the processor 44, cause the controller 34 to the perform logic, calculations, methods and/or algorithms described herein for generating a binary true/false classification output that may be used to generate a valid DOA 307 command.

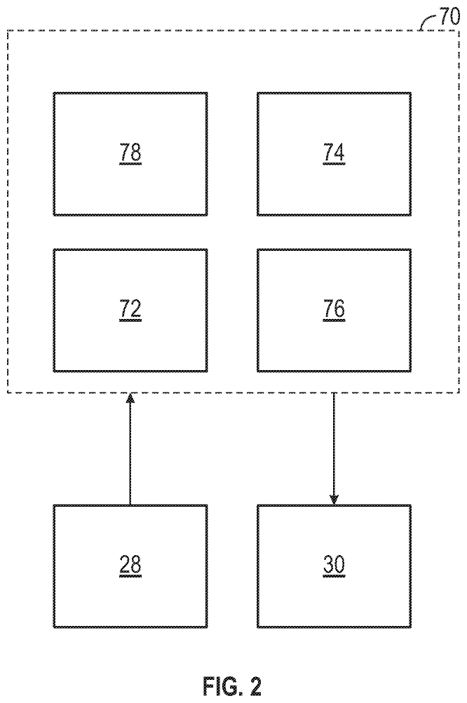

In practice, the instructions (including instructions 50 and/or program 52) may be organized (e.g., combined, further partitioned, etc.) by function for any number of functions, modules, or systems. For example, in FIG. 2, the controller 34 is described as implementing a driving system 70. The driving system 70 may be autonomous or semi-autonomous. The driving system 70 generally receives sensor signals from sensor system 28 and generates commands for the actuator system 30. In various embodiments, the driving system 70 can include a positioning system 72, a path planning system 74, a vehicle control system 76, and a perception system 78.

The positioning system 72 may process sensor data along with other data to determine a position (e.g., a local position relative to a map, “localization,” an exact position relative to a lane of a road, a vehicle heading, etc.) of the vehicle 100 relative to the environment. As can be appreciated, a variety of techniques may be employed to accomplish this localization, including, for example, simultaneous localization and mapping (SLAM), particle filters, Kalman filters, Bayesian filters, and the like.

The path planning system 74 may process sensor data along with other data to determine a path for the vehicle 100 to follow. The vehicle control system 76 may generate control signals for controlling the vehicle 100 according to the determined path. The perception system 78 may synthesize and process the acquired sensor data to predict the presence, location, classification, and/or path of objects and features of the environment of the vehicle 100.

As mentioned, embodiments of the DOA system 302 are described in the context of the perception system 78. Turning now to FIG. 3, the novel direction of arrival (DOA) system 302 is described in more detail. Illustration 300 shows that the radar transceiver 41 transmits and receives radar signals 303, generally in a three-dimensional volume. The received radar signals are understood to be reflected from objects and/or the environment external to the vehicle 100. While radar transceiver 41 is referred to in the singular, it is understood that, in practice, it represents a radar sensor array, each element of the radar array providing a sensed radar output, and that the radar data 305 comprises a linear combination of the sensed radar outputs. Further, the sensed outputs may be individually weighted to reflect a beamforming methodology that is used (for example, Bartlett or Capon beamforming). The radar transceiver 41 converts the received radar signals into radar data 305.

DOA system 302 receives radar data 305 from the radar transceiver 41 and converts the received radar data 305 into a response map 309 using a beamformer algorithm (indicated by beamformer module 304). The DOA system 302 performs target verification and false alarm (FA) elimination operations on the response map 309 (indicated by the novel target validation module 306) to generate therefrom a valid response map 311.

The peak response identifier module 308 includes a conventionally available detection stage and a conventionally available peak response algorithm. In the detection stage, the peak response identifier module 308 may processes the received response map with statistical algorithms that are employed to distinguish between valid targets and noise; however, due to their statistical character, the statistical algorithms alone fail from time to time. In the peak response stage, the peak response identifier module 308 performs conventionally available peak response identification operations on the spectral data making up the valid response map 311 to identify a strongest signal therein, and the strongest signal indicates the DOA, becoming the valid DOA 307 command. Since the statistical algorithms are not 100% accurate, it is the addition of the target verification and false alarm elimination provided by the novel DOA system 302 that assures that, in the beamforming stage, only valid response maps 311 are processed, response maps 309 that are deemed false alarms (FA) are ignored.

The valid DOA 307 command may be transmitted to one or more of: the actuator system 30, the steering system 24, the braking system 26, the positioning system 72, the vehicle control system 76, and the path planning system 74.

The response map 309 is a three-dimensional image, or snapshot, representing the external environment of the vehicle. Two of the dimensions represent a two-dimensional pixelated area, like a flat “picture,” and the third dimension provides an intensity at each pixel. Using the response map 309, the technical problems that the target validation module 306 solves are: (1) is there a valid object in this image? and, (2) if so, where is the object located?

In various embodiments, the controller 34 implements deep neural network techniques to assist the functionality of the target validation module 306. Embodiments of the example target validation module 306 comprise a convergent neural network (CNN) 310 with multiple hidden convolution layers. The CNN 310 directly answers the first question; the trained CNN 310 can determine if the response map has within it a valid object (for example, a car or a pedestrian), or whether the response map only has noise within it (a false alarm). The binary true/false output 313 of CNN 310 is used to answer the second question. The novel target validation module 306 effectively gates (i.e., removes or filters out) the false alarm response maps so that false alarm response maps are not processed by the peak response identifier module 308. This advantageously saves computational time in the peak response identifier module 308 and averts the possibility that question (2) is answered (with the generation of a DOA 307) for a false target.

Turning now to FIG. 4, and with continued reference to FIGS. 1-3, the CNN 310 is described, in accordance with various embodiments. The input node of the CNN 310 receives the response map 309, which as previously stated, is a spectral image/map, and therefore distinct from a time domain map. In the example CNN 310, a sequence of convolution hidden layers is repeated, in series, a total of N times. The hidden layers are represented as Hₙ, where n extends from 1 to N (referencing H₁ 402, H₂ 404, and H_{N} 406). In accordance with CNN methodology, a neuron or filter is chosen (a design choice) for the convolution of the input image (response map 309) to the first hidden layer H₁ 402. The neuron or filter has “field dimensions,” and the application and the field dimensions affect the number and magnitude of weights, which are multipliers, associated with inputs to each neuron. The weights are set to an initial value, adjusted during the training process of the CNN 310, and continue to adjust during operation of the CNN 310. The dimensions of each hidden layer Hₙ are a function of the layer it operates on and the operations performed. Moving from each hidden layer Hₙ to a subsequent hidden layer Hₙ, design choices continue to inform the selection of subsequent neurons, respective weights, and operations.

Once a layer has been convolved, an activation function is used to give the output of the hidden layer Hₙ its non-linear properties. The activation function is a design and task specific choice. In various embodiments of the CNN 310, a rectified linear unit (ReLU) activation function is chosen for the hidden layers because it produces the best performance in the CNN and provides a computationally simple thresholding of values less than zero.

Also, in accordance with CNN methodology, other layers and operations may be interspersed between the convolution hidden layers. In the example of FIG. 4, the sequence Hₙ is {convolution and ReLu layer 408, which includes Max Pooling, Batch Normalization layer 410, and Dropout layer 412}. Max Pooling is a down-sampling methodology, in that it is used to reduce the number of parameters and/or spatial size of the layer it is applied to. Batch Normalization 410 is a methodology for reducing internal covariate shift and can speed up training time. Dropout 412 is a methodology for randomly dropping a neuron when executing the CNN 310 in order to avoid overfitting and speed up the training time.

Each hidden layer Hₙ takes its input from the previous hidden layer, and there are no other inputs to the hidden layers Hₙ. N is referred to as a hyperparameter and is determined by experience or trial and error. Designers notice that when N is too large issues such as overfitting and poor generalization of the network can occur. In an embodiment, the response map 309 is a three-dimensional tensor of dimensions 15×20×3, to accommodate larger response maps, the CNN 310 can be made deeper.

At the end of the Nth sequence of convolution hidden layers, a fully connected layer 414 (also referred to as a dense layer) is used for classification. Fully connected (FC) layer 414 receives a three-dimensional input and converts it, or flattens it, into a binary true/false classification of true target/false alarm, as binary true/false output 313. In various embodiments, the activation function for the fully connected layer 410 is a nonlinear sigmoid function

$$f ( z ) = \frac{1}{( 1 + {e}^{- z} )} .$$

Turning now to FIG. 5, a process flow chart depicting an example process 500 for training the CNN 310 for use in the target validation module 306 is described. Due to the nature of the CNN 310, training the CNN 310 is interchangeable with configuring the CNN 310 by a processing system. The example CNN 310 is trained using a backpropagation method. The example CNN 310 is trained with a training data set and a validation data set that each include a plurality of example response maps that are valid (represent a verified target) and a plurality of example response maps that are invalid (represent a false alarm). In various embodiments, the training data is the same as the validation data.

Training the CNN 310 comprises retrieving or receiving a training data set (operation 502) and retrieving or receiving a validation data set (operation 504). In various embodiments, the training data set and validation data set are the same and have been generated using known target in an anechoic chamber to generate radar data, and that radar data is then converted with a beamformer operation into a response map. In various embodiments, the beamformer operation is a Bartlett beamformer algorithm. Training the CNN 310 (operation 506) is as follows: The CNN 310 is trained using the entire training data set, one entry at a time, in random order, with the entire validation data set. One pass over the training data set is called an epoch, and the number of epochs used for training is generally a function of the size of the training data set and the complexity of the task. In each epoch, a training error and a test error are generated, for example, as a cyclic piecewise linear loss function, and the training error and the test error are compared to their previous value, and to each other. As applied to the CNN 310, the number of epochs is related to the value N, and the number of epochs is determined by continuing to increase it while the training error and the test error are decreasing together. Once the test errors stabilize, no further epochs are performed; any further epochs are expected to cause overfitting.

Once trained, the CNN 310 is configured to process the spectral data in the response map 309 to determine whether the response map 309 represents a valid target detection and generate a respective output, which is the binary true/false output 313. As may be appreciated, true indicates a valid target and false indicates a false alarm. Upon completing the training, the trained CNN 310 is saved in memory at operation 508. It is understood that once trained, the CNN 310 may continue to be trained while being used in an actual application.

FIG. 6 is a process flow chart depicting an example process 600 for generating a direction of arrival (DOA 307) command using the trained CNN 310 to detect and remove false alarms/false targets in a DOA system 302 for a vehicle 100.

The example process 600 includes using the trained CNN 310 in the calculation of the DOA. A response map 309 is received (operation 602). The response map 309 is provided as an input to the trained CNN 310. The CNN 310 executes using the response map 309 as an input layer, and generates the binary true/false output 313 based thereon (operation 604).

At operation 606, false alarm elimination logic 350 receives the binary true/false output 313 and removes false alarm detections (ie. response maps having false alarms). False alarm elimination logic 350 is designed to operate quickly; FIGS. 7 and 8 provide example embodiments of the false alarm elimination logic 350. Only valid response maps 311 are sent to the peak response identifier module 308 from operation 606. At operation 608, the peak response (i.e., the maximum value) within the valid response map 311 is identified. At operation 610, the output DOA 307 command is generated as a function of the maximum value or peak response. The generated DOA 307 command may be provided to the actuators and/or to other systems in the vehicle 100.

The combination of the CNN 310 and the false alarm detection logic 350 delivers a very fast determination of validity of the incoming response map, which enables fast elimination of false alarms prior to performing the operations involved in a a peak response identification. Accordingly, the false alarm detection logic 350 is implemented with components that optimize the speed of the false alarm elimination. In FIG. 7, an embodiment of the false alarm detection logic 702 utilizes a switch S1 700, which is controlled by the incoming binary true/false output 313 of the CNN 310. Only when binary true/false output 313 is true, the switch S1 700 is closed and the response map 309 flows directly to become valid response map 311. When binary true/false output 313 is false, the switch S1 700 is open and the response map 309 does not pass. In an embodiment, the switch S1 700 is implemented with a logic “AND” gate. In FIG. 8, an embodiment of the false alarm detection logic 802 utilizes a processor 804 and memory 806. Memory 806 has stored therein programming instructions 808, which directs the operation “if and only if binary true/false output 313 is true, the response map 309 flows directly to become valid response map 311.”

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A processor-implemented method for using radar data to generate a direction of arrival (DOA) command using a convolutional neural network (CNN), the method comprising:
generating a response map from the radar data;
processing, in the CNN, the response map to determine whether the response map represents a valid target detection;
classifying, by the CNN, the response map as a false alarm when the response map does not represent a valid target detection; and
identifying a maximum value in the response map when the response map does represent a valid target detection.

2. The method of claim 1, wherein the response map is a Bartlett beamformer spectral response map.

3. The method of claim 2, wherein the CNN has been trained using training data generated in an anechoic chamber.

4. The method of claim 3, wherein the response map is a three-dimensional tensor of dimensions 15×20×3.

5. The method of claim 4, wherein the CNN is trained using back propagation.

6. The method of claim 5, wherein the CNN comprises a plurality of hidden layers.

7. The method of claim 6, wherein each of the hidden layers comprise a convergent layer with a rectified linear unit (ReLU) activation function.

8. The method of claim 7, wherein each of the hidden layers further comprise Batch Normalization layers, MaxPooling layers, and Dropout layers.

9. The method of claim 8, wherein the CNN comprises at least one fully connected layer (FC) with a sigmoid activation function.

10. A processor-implemented method for removing false alarms at the beamforming stage for sensing radars using a convolutional neural network (CNN), the method comprising:
receiving a response map generated from radar data;
processing, in the CNN, the response map to determine whether the response map represents a valid target detection;
classifying, by the CNN, the response map as a false alarm when the response map does not represent a valid target detection; and
classifying, by the CNN, the response map as a valid response map when the response map does represent a valid target detection.

11. The method of claim 10, wherein the response map is a Bartlett beamformer spectral response map.

12. The method of claim 11, wherein the CNN has been trained using training data generated in an anechoic chamber and validation data generated in the anechoic chamber.

13. The method of claim 12, wherein the CNN is trained using back propagation.

14. The method of claim 13, wherein the response map is a three-dimensional tensor of dimensions 15×20×3, and the CNN comprises a number, N, of hidden layers, wherein N is a function of at least the dimensions of the response map.

15. The method of claim 14, wherein each of the N hidden layers comprise a convergent layer with a rectified linear unit (ReLU) activation function.

16. The method of claim 15, wherein the N hidden layers are interspersed with Batch Normalization layers, MaxPooling layers, and Dropout layers.

17. The method of claim 16, wherein the CNN comprises at least one fully connected layer (FC) with a sigmoid activation function.

18. A system for generating a direction of arrival (DOA) command for a vehicle comprising one or more processors programmed to implement a convolutional neural network (CNN), the system comprising:
a radar transceiver providing radar data;
a processor programmed to receive the radar data and generate therefrom a Bartlett beamformer response map; and
wherein the CNN is trained to process the response map to determine whether the response map represents a valid target detection, and classify the response map as a false alarm when the response map does not represent a valid target detection; and
wherein the processor is further programmed to generate the DOA command when the response map does represent a valid target detection.

19. The system of claim 18, wherein the processor is further programmed to identify a peak response in the response map when the response map does represent a valid target detection.

20. The system of claim 19, wherein the processor is further programmed to train the CNN using back propagation and using a training data set and a validation data set that are each generated in an anechoic chamber.
